(19) United States
(12) Patent Application Publication
(10) Pub. No.: US 2014/0132625 A1
(43) Pub. Date: May 15, 2014

(54) ACCESS TO PAPER BASED MAIL IN ELECTRONIC FORMAT

(71) Applicant: OUTBOX, INC., Austin, TX (US)

(72) Inventors: Jason Gregory Seriff, Austin, TX (US); Michael Joseph Dellanoce, Austin, TX (US); Joyce Lee, Austin, TX (US); William Jewell Davis, JR., Austin, TX (US); Evan John Baehr, Austin, TX (US)

(73) Assignee: OUTBOX, INC., Austin, TX (US)

(21) Appl. No.: 13/672,849

(22) Filed: Nov. 9, 2012

(51) Int. Cl. G06F 3/0484

(52) U.S. Cl. CPC G06F 3/04842
USPC 345/619

(57) ABSTRACT

The present invention generally relates to permitting an intended recipient to access snail mail in electronic format. A third party retrieves the snail mail and then converts the snail mail into electronic files. The electronic files are then made available to the intended recipient over the internet. The electronic files are digital images of each envelope as well as the contents of each envelope. The contents are associated with the envelope from which the contents are retrieved. If desired, the intended recipient can select a desired image resolution or quality. The intended recipient can select which envelopes to view based upon the day and also based upon the class of mail.

### BACKGROUND OF THE INVENTION

1. Field of the Invention

Embodiments of the present invention generally relate to accessing paper-based mail, which is typically received from a postal carrier (i.e., snail mail), in electronic format.

2. Description of the Related Art

It is a digital world, yet most people are still tethered to their mailbox to receive bills and other paper-based communications. Many households have access to the internet and are moving to paperless bill-pay whereby the bill is never printed in paper form, but rather, is delivered electronically to the intended recipient. Not all businesses are sophisticated enough to have electronic delivery of bills and thus rely upon paper-based communication. Therefore, to date, some bills (and incidentally, the rest of the paper-based mail) are delivered by the postal carrier and complete elimination of snail mail has not happened.

Additionally, when people travel, oftentimes they will have someone pick up their snail mail for them. Alternatively, rather than have someone pick up their snail mail, people will make a special trip to their local Post Office and complete paperwork to have the United States Postal Service (USPS) stop delivery of snail mail for a specified period of time. Of course, during the time on travel, the snail mail is at home (or at the Post Office) and not accessible.

Thus, there is a need in the art for a more convenient manner of receiving snail mail delivered by the USPS.

### SUMMARY OF THE INVENTION

The present invention generally relates to permitting an intended recipient to access snail mail in electronic format. A third party retrieves the snail mail and then converts the snail mail into electronic files. The electronic files are then made available to the intended recipient over the internet. The electronic files are digital images of each envelope as well as the contents of each envelope. The contents are associated with the envelope from which the contents are retrieved. If desired, the intended recipient can select a desired image resolution or quality. The intended recipient can select which envelopes to view based upon the day and also based upon the class of mail.

In one embodiment, a method comprises displaying an image of one or more envelopes addressed to an intended recipient, wherein the image is contained in a first file; receiving input indicating a selection of a first of the one or more envelopes; and displaying, in response to receiving the input, images representing the contents of the first envelope.

In another embodiment, a computer readable storage medium storing instructions capable of being executed by a processor, which, when executed, perform an operation, comprises: displaying an image of one or more envelopes addressed to an intended recipient, wherein the image is contained in a first file; receiving input indicating a selection of a first of the one or more envelopes; and displaying, in response to receiving the input, images representing the contents of the first envelope.

In another embodiment, a system, comprises: a processor; a memory storing one or more application programs, which, when executed on the processor, are configured to perform an operation, comprising: displaying an image of one or more envelopes addressed to an intended recipient, wherein the image is contained in a first file; receiving input indicating a selection of a first of the one or more envelopes; and displaying, in response to receiving the input, images representing the contents of the first envelope.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flowchart illustrating the process of converting snail mail into to electronic files according to one embodiment.

FIG. 2 shows a user interface for the intended recipient to access their electronic files.

FIG. 3 shows a user interface for the intended recipient to access a particular day's mail.

FIG. 4 shows the second page of a multi-page image of a piece of mail selected by the user.

FIG. 5 shows the user interface for adding to or creating stacks of mail.

FIG. 6 shows the user interface for the “to do” interactive screen used by the user.

FIG. 7 shows the personal mail identified by the user.

FIG. 8 illustrates a computing system configured for delivering electronic mail, according to one embodiment.

FIG. 9 is a more detailed view of a mail server of FIG. 8 within which embodiments of the invention may be implemented.

FIG. 10 illustrates an example of a computing system used view online content, according to certain embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present invention generally relates to permitting an intended recipient to access snail mail in electronic format. A third party retrieves the snail mail and then converts the snail mail into electronic files. The electronic files are then made available to the intended recipient over the internet. The electronic files are digital images of each envelope as well as the contents of each envelope. The contents are associated with the envelope from which the contents are retrieved. If desired, the intended recipient can select a desired image resolution or quality. The intended recipient can select which envelopes to view based upon the day and also based upon the class of mail.

In operation, the intended recipient signs-up with an electronic mail delivery service, such as Outbox, Inc., and authorizes the electronic mail delivery service to retrieve the intended recipient's paper-based mail (i.e., snail mail) and then deliver the paper-based mail in an electronic format. The electronic mail delivery service could be authorized to retrieve all mail (excluding packages). Packages could continue to be delivered through the USPS. In one embodiment, the electronic mail delivery service can be authorized to retrieve all mail, including packages. Once retrieved, the paper-based mail would be converted by the electronic mail delivery service into an electronic format. The electronic mail would then be available to the intended recipient.

### Retrieval of the Mail

As discussed briefly above, the intended recipient of the snail mail authorizes a third party electronic mail delivery service, such as Outbox, Inc., to either retrieve the snail mail at the intended recipient's mailbox or to intercept the snail mail at a sorting facility of the USPS. The third party will then be able to retrieve/intercept the snail mail before the intended recipient retrieves the mail from the mailbox.

It is important to understand the difference between retrieving the snail mail from the intended recipient's mailbox and receiving the snail mail from a mailbox that the intended recipient has requested snail mail be sent. In the latter, the intended recipient has either requested the USPS to forward the mail to another location (in which case, the intended recipient's address is still on the snail mail, but the USPS has added a new address label with the forwarding address) or has arranged for all mail to be addressed to a different location (e.g., an address in Oregon) than where the intended recipient actually resides. Either way, for ‘receiving’ the mail, the intended recipient needs to make a specific effort to change the location of where the snail mail is delivered. Retrieving the snail mail, on the other hand, simply involves collecting the snail mail from the mailbox at the address of the intended recipient where the intended recipient resides or operates a business. Another manner of considering the situation is that to ‘receive’ the snail mail, the intended recipient has designated the mailbox to which the snail mail is delivered by the USPS. To ‘retrieve’ snail mail, the third party collects the mail from the mailbox that services the intended recipient's residence (or business).

Snail mail delivered by the USPS comes in many forms. There is first class mail which includes such items as personal letters, birthday cards, bills, and bank statements to name a few. There is also second class mail which includes magazines and newspapers. Additionally, there is third class mail which includes mass mailings such as direct mail advertisements. Packages are oftentimes considered first class mail, but are considered a different type of mail as packages tend to weigh more than the standard first class mail and are typically bulkier than standard first class mail.

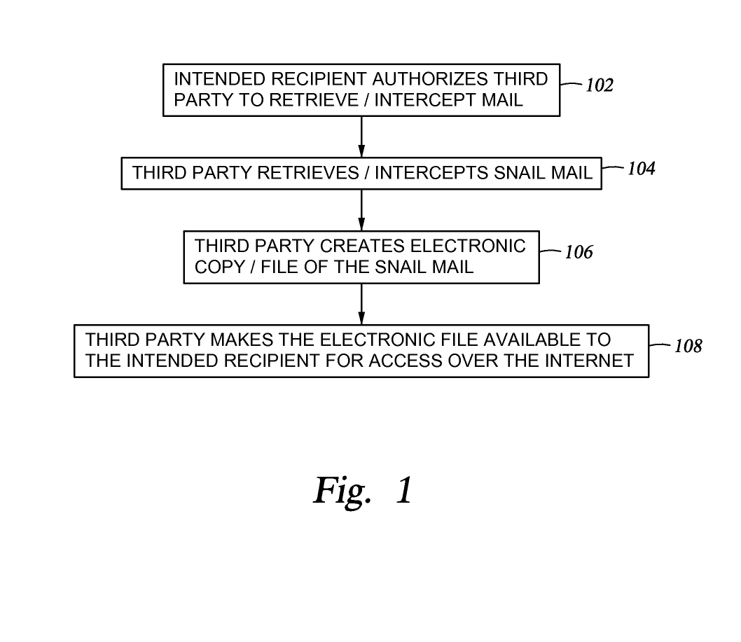

FIG. 1 is a flowchart illustrating the process of converting snail mail into to electronic files according to one embodiment. In one embodiment, the third party is authorized to retrieve/intercept first, second, and third class mail, but not to retrieve/intercept packages. In another embodiment, the third party is authorized to retrieve/intercept all mail that is delivered to the mailbox (Step 102).

No matter what level of authorization (i.e., first class, second class, third class, packages), the third party then proceeds to retrieve/intercept the snail mail everyday that mail is delivered to the mailbox, which is typically Monday-Saturday, except holidays (Step 104). The third party can retrieve/intercept the snail mail by well known means such as a representative of the third party going to specified mailbox or sort facility and retrieving the snail mail.

Now that the third party has intercepted/retrieved the snail mail, the third party can sort the mail into the various classes of mail (i.e., first class, second class, third class) and then convert the snail mail into electronic mail (Step 106). The snail mail may be converted in a number of ways such as scanning the snail mail to create an electronic file or taking a digital image of the snail mail to create an electronic file. The electronic file with then be available to the intended recipient over the internet (Step 108). In one embodiment, the electronic files for only the first class mail will be made available to the intended recipient. In another embodiment, all of the snail mail images (excluding packages) received by the third party will be make available to the intended recipient.

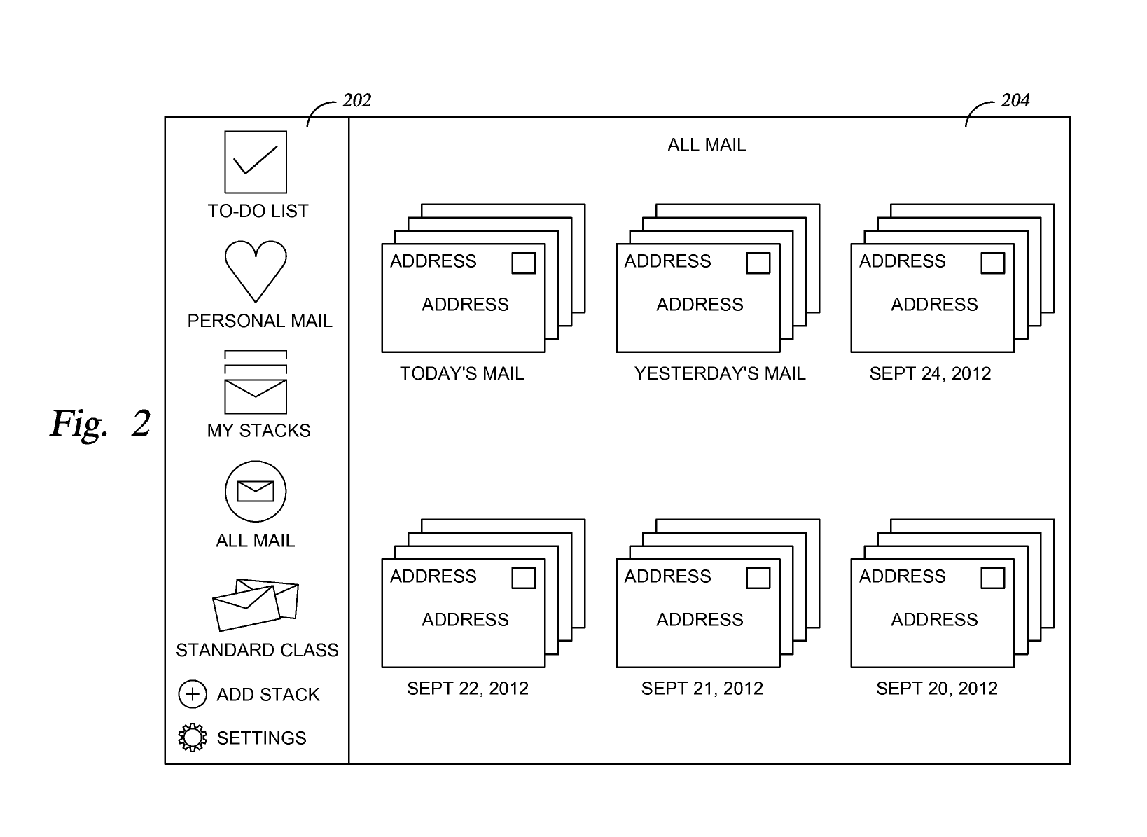

Once available to the intended recipient, the intended recipient will access the electronic files via the internet. The intended recipient will be able to access the files via a personal computer, a notebook computer or even a smart phone. FIG. 2 shows a user interface for the intended recipient to access their mail that has been converted into electronic files. As shown in FIG. 2, a toolbar 202 shows several different options for the user while the main workspace 204 includes the mail. In the main workspace, the mail is separated by days. It is to be understood that while the mail is organized by days, the mail may be organized by weeks or months or even years. The toolbar 202, as will be discussed below, contains several different options for viewing in the workspace 204.

Within the all mail workspace shown in FIG. 2, the mail is shown organized by day. The icon for the day includes an image of an actual item of mail retrieved/intercepted by the third party recipient. If the user wants to view a particular day's mail, the user can click on the icon for the particular day desired. Additionally, the mail may be sorted by class so that only first class mail is shown.

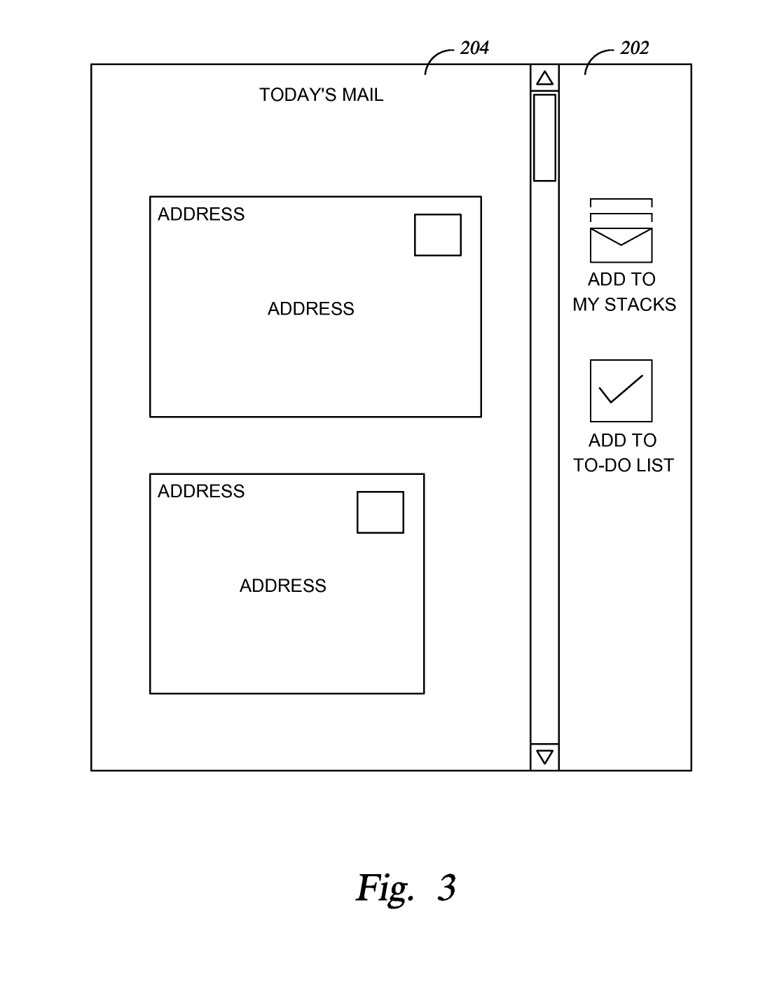

Once the particular day is selected, the user can then see all of the mail for the day. FIG. 3 shows a user interface for the intended recipient to access a particular day's mail. As shown in FIG. 3, each piece of mail is identified by an image of the actual piece of mail as the user would see if actually holding the piece of mail in hand. The user may click on the particular piece of mail that they would like to open, scroll down the screen to see different pieces of mail (if all pieces of mail do not fit onto the screen), select a piece of mail for the to do list or add a piece of mail to a stack.

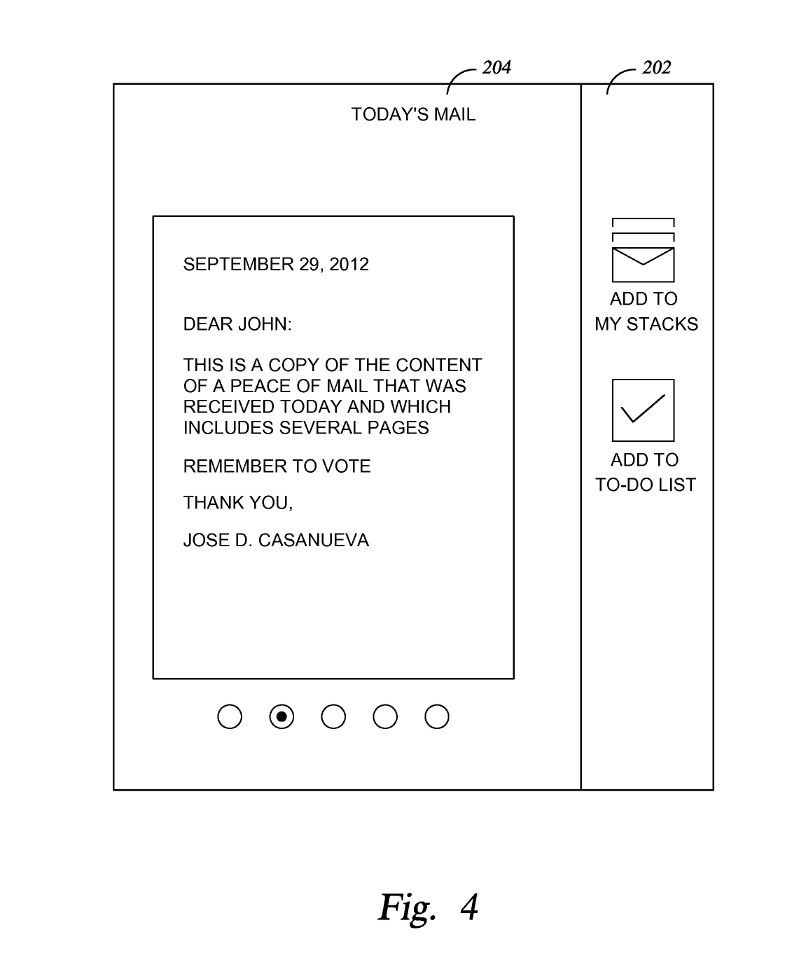

If the user selects a particular piece of mail to view, the user clicks on the mail, in which case the mail opens up so that the user sees images of the contents of the piece of mail. FIG. 4 shows the second page of a multi-page image of a piece of mail selected by the user. As can be seen, the user has the option, as before, of adding the piece of mail to a stack or to the “to do” list. Additionally, the user can scroll between the pages of the document and view each page of the mail. Each separate page can be a separate file such that each page, together with the envelope are individual files that are associated with one another.

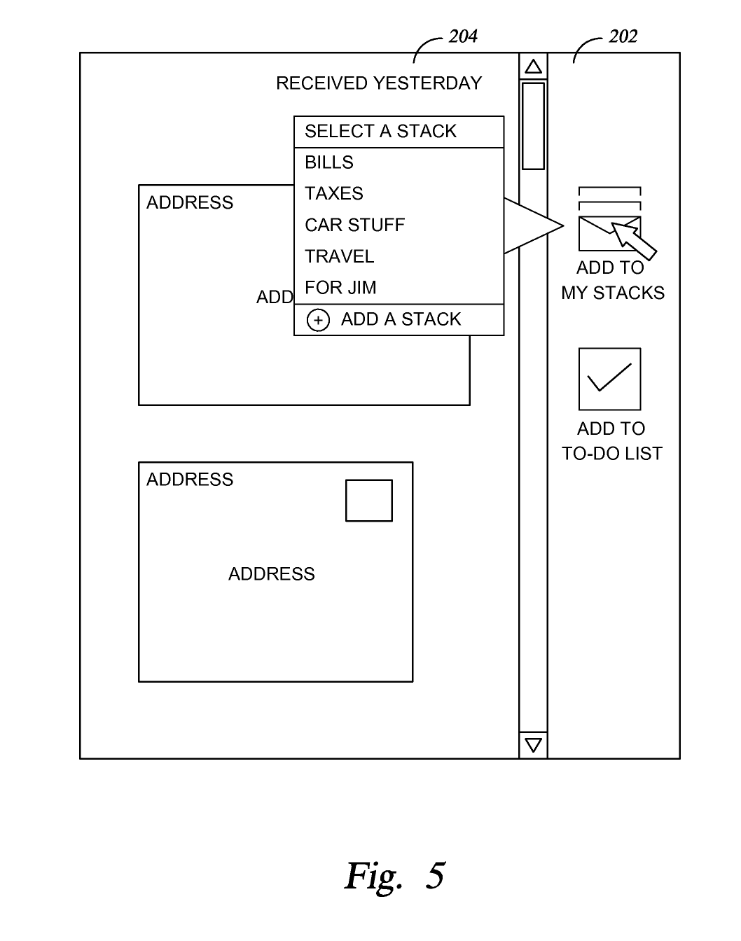

As noted above, each individual piece of mail may be sorted and placed into a stack. FIG. 5 shows the popup menu that appears upon clicking the “Add to stack” icon next to the mail. As can be seen from FIG. 5, the user can customize the stacks based upon the any criteria selected by the user. In FIG. 5, the user has already created several stacks for sorting the mail.

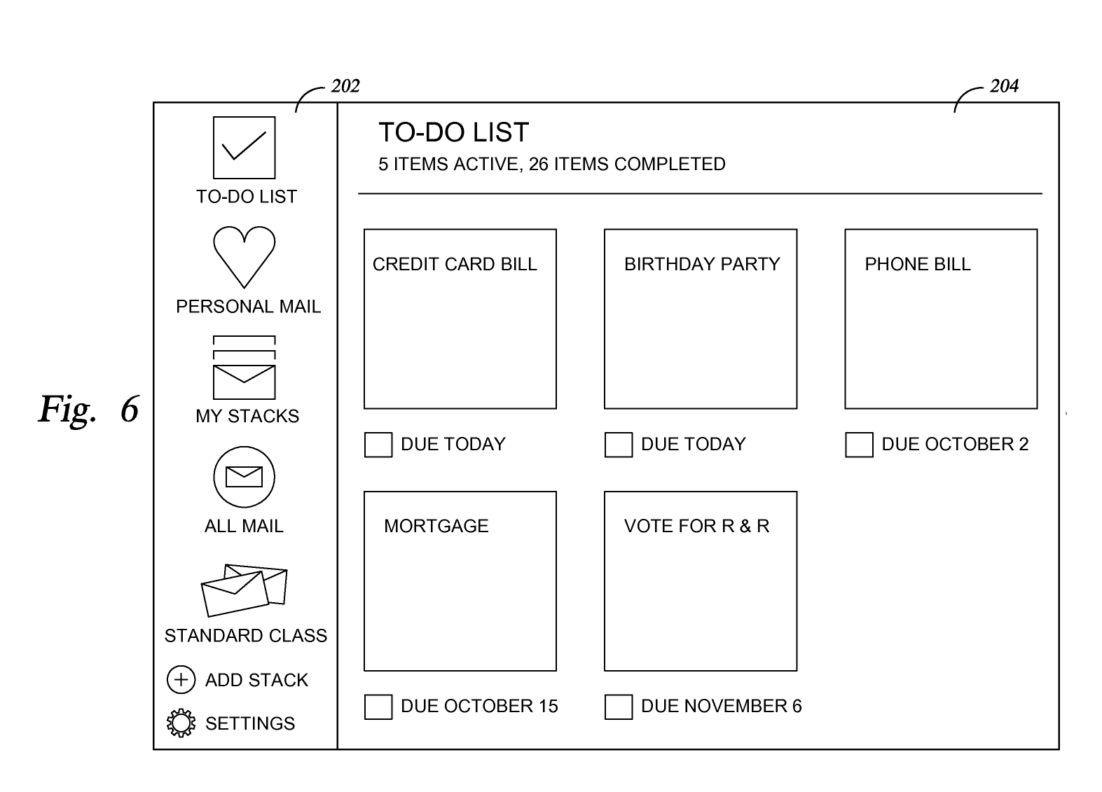

Additionally, a piece of mail may be a basis for a follow-up for the user. For example, a piece of mail may be a bill that needs paying. The user can therefore add the piece of mail to a “to do” list by selecting the “to do” icon. FIG. 6 shows the “to do” window interface whereby the user is able to create reminders to alert the user. The alerts may be arranged to send automatic email reminders, to post in the user's calendar program, and/or to remind the user upon logging accessing the webpage.

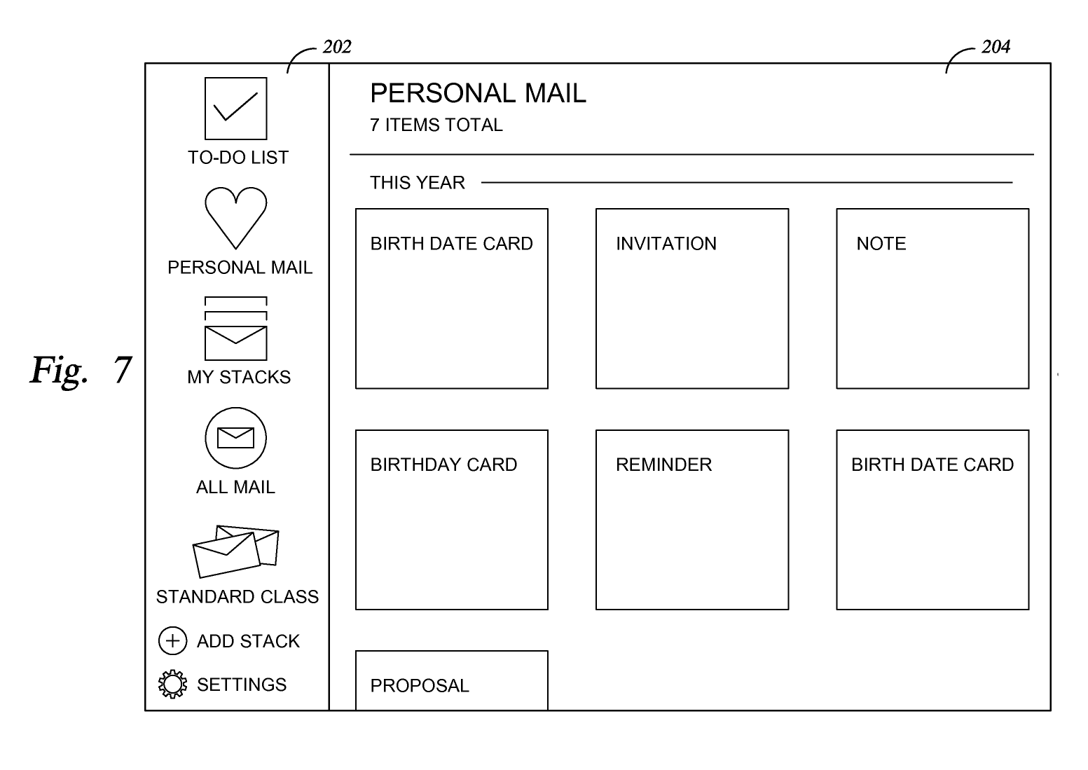

The user may also wish to sort out personal mail from bills or lower class mail. The user may sort their personal mail such that the personal mail is viewing by selecting the “Personal Mail” icon. FIG. 7 shows the personal mail user interface according to one embodiment. In the personal mail section, the user can view personal mail that the user has selected to maintain within the personal mail section. The personal mail may be maintained for a predetermined period of time arranged by the user and the third party. As shown in the Figures, the user can click on an icon in the toolbar 202 in order to navigate to different portions of the website to access the electronic files.

The snail mail will be maintained by the third party for an agreed upon time period, such as about 30 days, after which, the snail mail will be shredded. Upon viewing the electronic mail, the intended recipient may request the original snail mail to be delivered. Upon receiving such a request, the third party will hand deliver the original snail mail. If the third party retrieves any, the third party will hand deliver the package to the intended recipient.

To convert the snail mail to electronic mail, the third party opens the snail mail and removes the contents from the envelopes. The envelope, and the contents, and converted to electronic files. In one embodiment, the envelopes and contents are scanned to create electronic files. In another embodiment, digital images are taken of the envelopes and contents to create electronic files.

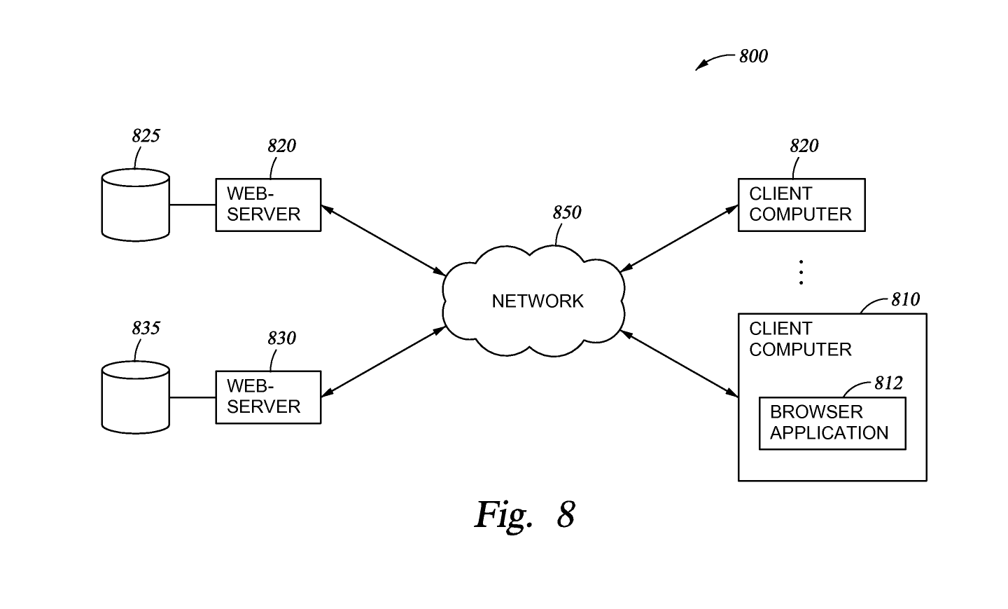

FIG. 8 illustrates a computing system 800 configured for delivering electronic mail, according to one embodiment of the invention. As shown, the computing system 800 includes a web server 820 and a user computer 810 that are each connected to a communications network 850 (e.g., the Internet). For example, the web server 820 may be programmed to communicate with the intended recipient's computer 810 using a networking protocol such as TCP/IP protocol.

The computer 810 may include conventional components of a computing device, e.g., a processor, system memory, a hard disk drive, input devices such as a mouse and a keyboard, and/or output devices, such as a monitor. The web server 820 includes a processor and a system memory (not shown), and may be configured to manage web pages and other media content stored in its respective content storage unit 825 using a file system and/or relational database software. The mail server 830 is a web server configured to manage the electronic mail files that contain the images stored in its respective content storage unit 835. In one embodiment, the mail server 830 may be configured to manage the electronic mail described herein.

In the embodiments of the present invention, the intended recipient operates the user computer 810 that may communicate over the network 850 to request webpages and other media content data from the web server 820. The user computer 810 may be configured to execute a software application, such as a web browser application 812, and access webpages and/or media content data managed by the web server 820 by specifying a uniform resource locator (URL) for the web server 820 into the web browser application 812. The webpages that are displayed to an intended recipient are transmitted from the web server 820 to the computer 810 and processed by the web browser application 812 for display through a monitor of the computer 810.

It is noted that the computer 810 may be a personal computer, laptop, mobile computing device, smart phone, video game console, home digital media player, network-connected television, set top box, and/or other computing devices having components suitable for communicating with the communications network 350.

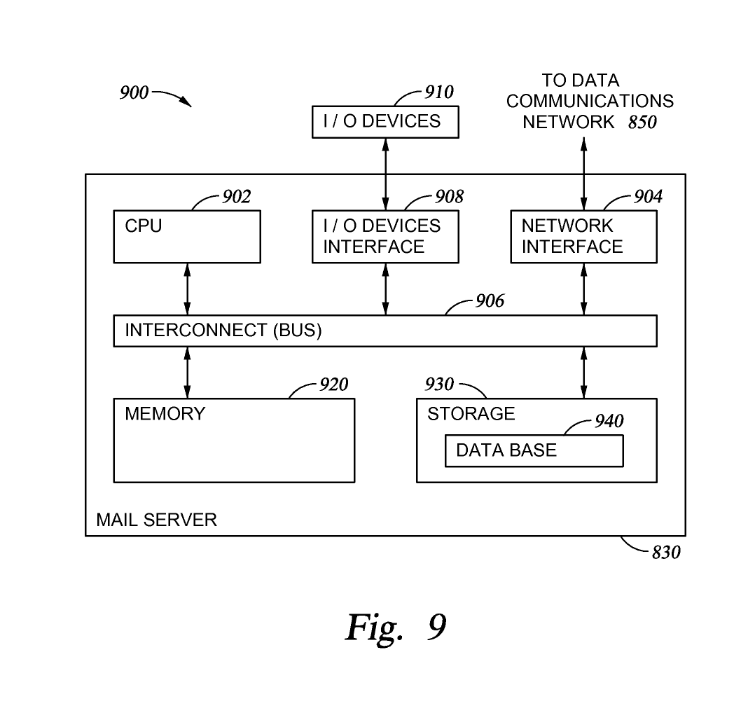

FIG. 9 is a more detailed view of the mail server 830 of FIG. 8 within which embodiments of the invention may be implemented. As shown, the mail server 830 includes, without limitation, a central processing unit (CPU) 902, a network interface 904, memory 920, and storage 930 communicating via an interconnect bus 906. The mail server 830 may also include I/O device interfaces 908 connecting I/O devices 910 (e.g., keyboard, video, mouse, audio). The mail server 830 may further include a network interface 904 configured to transmit data via the communications network 850.

The CPU 902 retrieves and executes programming instructions stored in the memory 920 and generally controls and coordinates operations of other system components. Similarly, the CPU 902 stores and retrieves application data residing in the memory 920. The CPU 902 is included to be representative of a single CPU, multiple CPUs, a single CPU having multiple processing cores, and the like. The interconnect bus 906 is used to transmit programming instructions and application data between the CPU 902, I/O devices interface 908, storage 930, network interface 904, and memory 920.

The memory 920 is generally included to be representative of a random access memory and, in operation, stores software applications and data for use by the CPU 902. Although shown as a single unit, the storage 930 may be a combination of fixed and/or removable storage devices, such as fixed disc drives, floppy disc drives, hard disk drives, flash memory storage drives, tape drives, removable memory cards, CD-ROM, DVD-ROM, Blu-ray, HD-DVD, optical storage, network attached storage (NAS), or a storage area-network (SAN) configured to store non-volatile data.

According to embodiments of the invention, the memory 920 stores instructions and logic for delivering the requested images by the intended recipient. The storage 930 stores snail mail images as electronic files 932 and includes a database 940 configured to store data for associating the respective images with a particular envelope or a particular intended recipient or a particular day of mail. The mail server 830 responds to requests from clients, such as the web browser 830, for snail mail images. In one embodiment, the database 940 comprises a relational database. In one embodiment, the database 940 is any type of storage device.

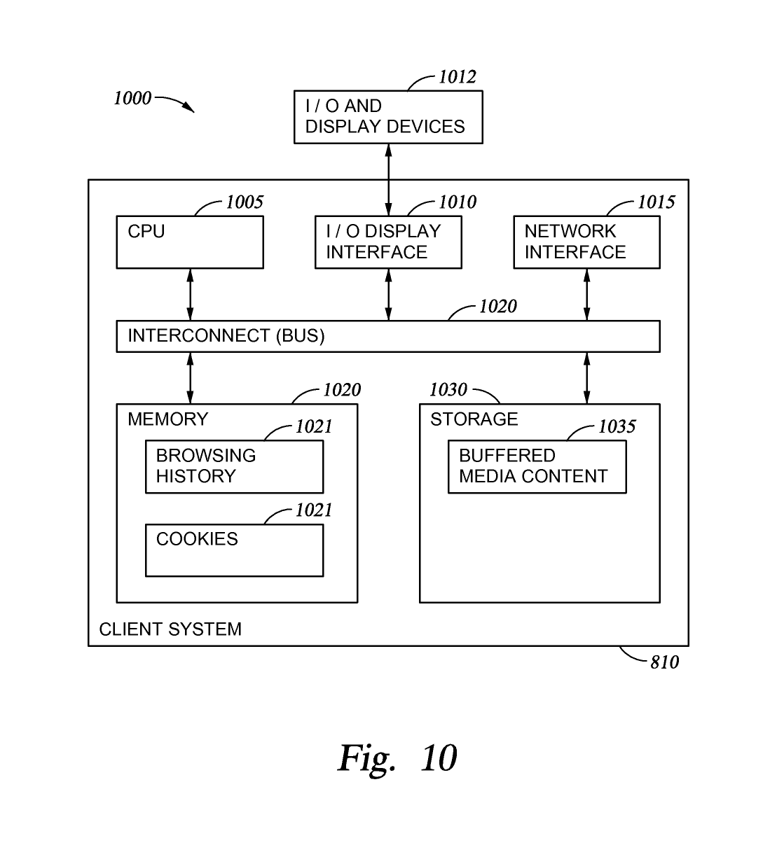

FIG. 10 illustrates an example of a client computing system 810 used to view online content, according to certain embodiments of the present disclosure. As shown, the client computing system 810 includes, without limitation, a central processing unit (CPU) 1005, a network interface 1015, an interconnect 1020, a memory 1025, and storage 1030. The computing system 810 may also include an I/O device interface 1010 connecting I/O devices 1012 (e.g., keyboard, display and mouse devices) to the computing system 810.

Like CPU 902, CPU 1005 is included to be representative of a single CPU, multiple CPUs, a single CPU having multiple processing cores, etc., and the memory 1025 is generally included to be representative of a random access memory. The interconnect 1020 is used to transmit programming instructions and application data between the CPU 1005, I/O devices interface 1010, storage 1030, network interface 1015, and memory 1025. The network interface 1015 is configured to transmit data via the communications network 850, e.g., to stream content from the web server 820, as well as to present images of the snail mail from the mail server 830. Storage 1030, such as a hard disk drive or solid state (SSD) storage drive, may store non-volatile data. Illustratively, the memory 1025 includes a web browser 1032, which itself includes a browsing history 1021 and cookies 1023, and the storage 1030 stores buffered media content 1035. The browser 1032 provides a software application which allows a user to access web pages and other content hosted by a server.

While the foregoing is directed to embodiments of the present invention, other and further embodiments of the invention may be devised without departing from the basic scope thereof, and the scope thereof is determined by the claims that follow.

1. A computer readable storage medium storing instructions capable of being executed by a processor, which, when executed, perform an operation, comprising:
displaying an image of one or more envelopes addressed to an intended recipient, wherein the image is contained in a first file;
receiving input indicating a selection of a first of the one or more envelopes; and
displaying, in response to receiving the input, images representing the contents of the first envelope.

2. The computer readable storage medium of claim 1, further comprising:
receiving input indicating a selection of a resolution of the image; and
displaying the image, in response to receiving the input indicating a selection of a resolution of the image, wherein the image is from a second file having a different image resolution than the first image.

3. The computer readable storage medium of claim 1, wherein the image is an image of a first class envelope.

4. The computer readable storage medium of claim 1, wherein the image is an image of a second class envelope.

5. The computer readable storage medium of claim 1, wherein images representing the contents of the first envelope are associated with the image of the envelope.

6. The computer readable storage medium of claim 1, wherein a plurality of envelopes are displayed and wherein the plurality of envelopes all correspond to the same date of receipt on the intended recipient's mailbox.

7. The computer readable storage medium of claim 1, further comprising:
receiving input indicating selection of a specific date that mail was received in the intended recipient's mailbox; and
displaying images of one or more envelopes that correspond to snail mail received in the intended recipient's mailbox on the specific date.

8. A method, comprising:
displaying an image of one or more envelopes addressed to an intended recipient, wherein the image is contained in a first file;
receiving input indicating a selection of a first of the one or more envelopes; and
displaying, in response to receiving the input, images representing the contents of the first envelope.

9. The method of claim 8, further comprising:
receiving input indicating a selection of a resolution of the image; and
displaying the image, in response to receiving the input indicating a selection of a resolution of the image, wherein the image is from a second file having a different image resolution than the first image.

10. The method of claim 8, wherein the image is an image of a first class envelope.

11. The method of claim 8, wherein the image is an image of a second class envelope.

12. The method of claim 8, wherein images representing the contents of the first envelope are associated with the image of the envelope.

13. The method of claim 8, wherein a plurality of envelopes are displayed and wherein the plurality of envelopes all correspond to the same date of receipt on the intended recipient's mailbox.

14. The method of claim 8, further comprising:
receiving input indicating selection of a specific date that mail was received in the intended recipient's mailbox; and
displaying images of one or more envelopes that correspond to snail mail received in the intended recipient's mailbox on the specific date.

15. A system, comprising:
a processor;
a memory storing one or more application programs, which, when executed on the processor, are configured to perform an operation, comprising:
displaying an image of one or more envelopes addressed to an intended recipient, wherein the image is contained in a first file;
receiving input indicating a selection of a first of the one or more envelopes; and
displaying, in response to receiving the input, images representing the contents of the first envelope.

16. The system of claim 15, wherein the operation further comprising:
receiving input indicating a selection of a resolution of the image; and
displaying the image, in response to receiving the input indicating a selection of a resolution of the image, wherein the image is from a second file having a different image resolution than the first image.

17. The system of claim 15, wherein the image is an image of a first class envelope.

18. The system of claim 15, wherein the image is an image of a second class envelope.

19. The system of claim 15, wherein images representing the contents of the first envelope are associated with the image of the envelope.

20. The system of claim 15, wherein a plurality of envelopes are displayed and wherein the plurality of envelopes all correspond to the same date of receipt on the intended recipient's mailbox.

21. The system of claim 15, further comprising:
receiving input indicating selection of a specific date that mail was received in the intended recipient's mailbox; and
displaying images of one or more envelopes that correspond to snail mail received in the intended recipient's mailbox on the specific date.
